(19) United States
(12) Patent Application Publication
(10) Pub. No.: US 2011/0109553 A1
(43) Pub. Date: May 12, 2011

(54) WIRELESS TOUCHPAD MOUSE

(76) Inventors: Chih-Ming TSAO, Zhonghe City (TW); Ya-Ting Cheng, Zhonghe City (TW)

(21) Appl. No.: 12/941,569

(22) Filed: Nov. 8, 2010

(30) Foreign Application Priority Data
Nov. 10, 2009 (TW) 098220844

(51) Int. Cl. G06F 3/033; G09G 5/08; H04B 7/00

(52) U.S. Cl. 345/163; 455/41.2

(57) ABSTRACT

A wireless touchpad mouse includes a housing defining a start-up region and a control module mounted in the housing. When the user touches a start-up region of the housing, a switch unit is switched on. When received the switching signal from the switch unit and a static signal from a touch panel, the microprocessor of the control module samples the resonance frequency of the sound wave detected by a sound wave sensor, and drives a transmitter module to transmit a displacement signal indicative of the movement of the housing to an external electronic device for cursor control after recognition of the resonance frequency to be within a predetermined reference value.

This application claims the priority benefit of Taiwan patent application number 098220844, filed on Nov. 10, 2009.

### BACKGROUND OF THE INVENTION

1. Field of the Invention

The present invention relates to touchpad mice and more particularly, to a wireless touchpad mouse, which converts the resonance frequency produced into a voltage signal, upon touch of the housing by a user, for causing the power supply module to provide power supply, and enables the microprocessor to sample the resonance frequency after receipt of a switching signal from a switch unit at a start-up region of the housing and a static signal from a touch panel so that the touch control system is enabled when the sampled value is in conformity with a predetermined reference value.

2. Description of the Related Art

At the present time, keyboard and mouse are most frequently used in electronic devices as input tool means. A computer mouse can be used to substitute for the directional keys of a computer keyboard for moving the cursor on the display screen. In a computer system, a mouse is a requisite peripheral apparatus. Many application program and instruction inputs can be conveniently operated only through a mouse. The use of a mouse in a computer system enhances the convenience of use of the computer system.

Further, following fast development of electronic technology, computer mouse has been changed from the wired operation mode to a wireless operation mode, facilitating carrying, storage and use. Many electronic devices, such as desk computer, notebook computer, PDA, and etc., allow the use of a mouse for data input. A wireless mouse must be used with a receiver. The receiver can be inserted into a communication port of, for example, a notebook computer, and adapted for receiving signal from a wireless transmitter in the wireless mouse. The wireless mouse uses a battery to provide the necessary working voltage. When operating the wireless mouse, a triggering signal is transmitted by the wireless transmitter to the wires receiver to control the cursor on the display screen. When moving or operating the wireless mouse, a control signal is triggered to wake up the circuit system. This input device wakeup design saves power consumption. However, conventional wireless mice cannot avoid an accidental triggering to wake up the circuit system. When the user is absent and the housing of the wireless mouse is touched accidentally by a pet, tabletop item or any other object, the wireless mouse will be waked up, wasting power consumption. Further, when a button of the wireless mouse is touched as the wireless mouse is waked up accidentally, an errors instruction or program execution may occur, or the storage file or data may be deleted, causing a system failure. To avoid these problems, an improvement in this regard is necessary.

### SUMMARY OF THE INVENTION

The present invention has been accomplished under the circumstances in view. It is one object of the present invention to provide a wireless touchpad mouse, which enhances touch control accuracy and stability and the convenience for use, and avoids accidental wakeup of the wireless touchpad mouse by errors.

According to one aspect of the present invention, when a user touches the housing of the wireless touchpad mouse, a sound wave sensor converts the resonance frequency of the produced sound waves into a voltage for causing a power supply unit to output power supply. If the user touches a start-up region of the housing at this time, a switch unit is switched on. When received the switching signal from the switch unit and a static signal from a touch panel, the microprocessor of the control module samples the resonance frequency of the sound wave detected by the sound wave sensor, and drives a transmitter module to transmit a displacement signal indicative of the movement of the housing to an external electronic device for cursor control after recognition of the resonance frequency to be within a predetermined reference value.

According to another aspect of the present invention, when the user touches the touch panel and the start-up region of the housing, the microprocessor of the control module start to sample the resonance frequency of the sound wave detected by the sound wave sensor, and drive a transmitter module to transmit a displacement signal indicative of the movement of the housing to an external electronic device for cursor control after recognition of the resonance frequency to be within a predetermined reference value. If the user leaves the finger from the start-up region of the housing, the switch unit is switched off, and the power supply module is off, saving power consumption. At this time, the user can keep the hand rested on the housing of the wireless mouse without touching the start-up region. The design of the switch unit provides a multi-touch calibration system, enhancing touch control accuracy and stability and the convenience for use and the product's market competitiveness, and avoiding accidental wakeup of the wireless touchpad mouse by errors.

### BRIEF DESCRIPTION OF THE DRAWINGS

FIG. 1 is a perspective view of a wireless touchpad mouse in accordance with the present invention.

FIG. 2 is an exploded view of the wireless touchpad mouse in accordance with the present invention.

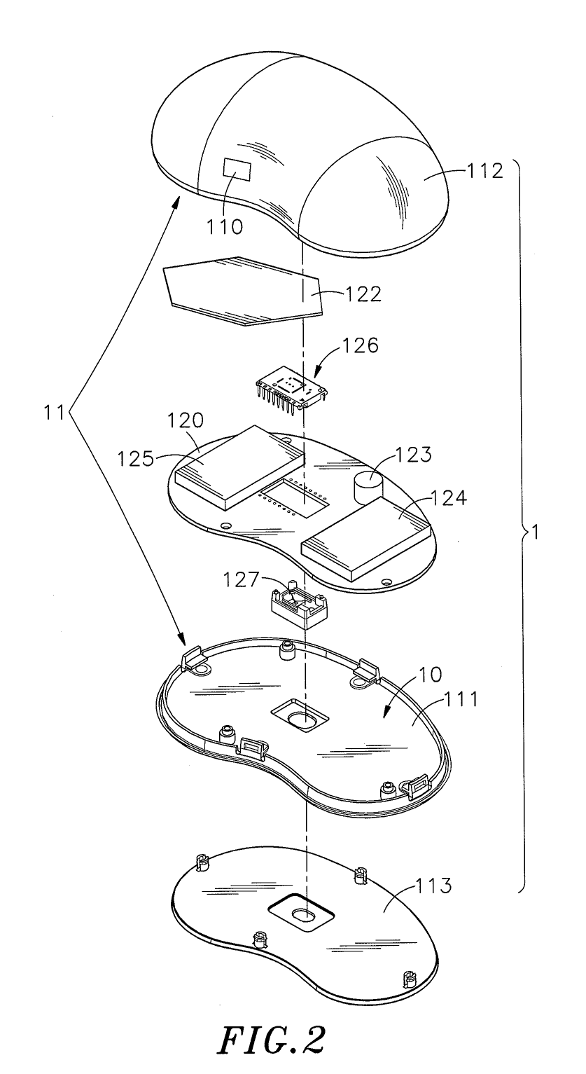

FIG. 3 is a circuit block diagram of the control module of the wireless touchpad mouse in accordance with the present invention.

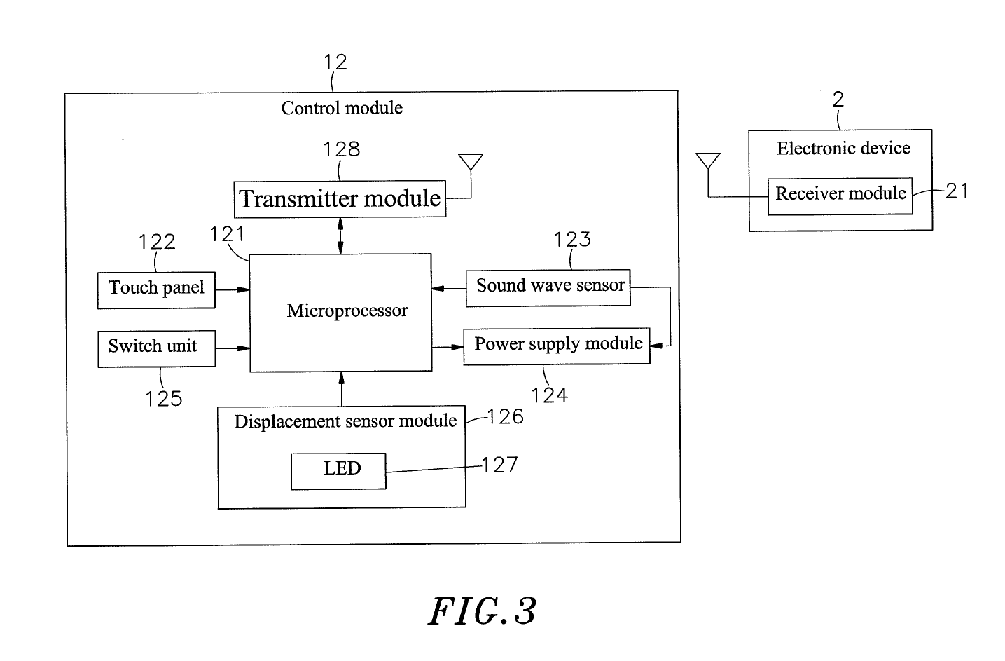

FIG. 4 is an operation flow chart of the wireless touchpad mouse in accordance with the present invention.

FIG. 5 is an alternate form of the operation flow chart of the wireless touchpad mouse in accordance with the present invention.

### DETAILED DESCRIPTION OF THE PREFERRED EMBODIMENT

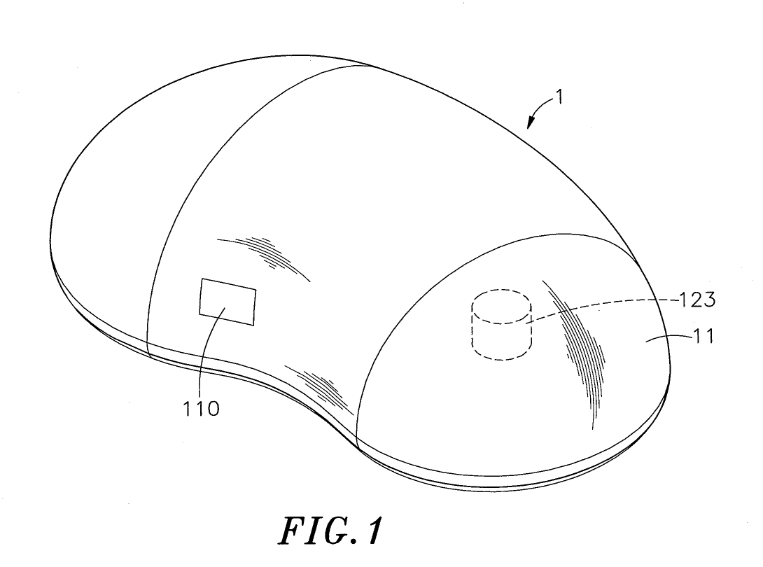

Referring to FIGS. 1˜3, a wireless touchpad mouse 1 in accordance with the present invention is shown comprising a housing 11 and a control module 12.

The housing 11 comprises a bottom cover shell 111, a top cover shell 112 covered on the top side of the bottom cover shell 111, an accommodation chamber 10 defined in between the bottom cover shell 111 and the top cover shell 112, and a cushion pad 113 fastened to the bottom side of the bottom cover shell 111. Further, the top cover shell 112 of the housing 11 defines a start-up region 110.

The control module 12 comprises a circuit board 120 carrying a circuit layout (not shown) and electronic components. These electronic components include a microprocessor 121, a touch panel 122, a sound wave sensor 123 and a power supply module 124. The microprocessor 121 is electrically connected with the touch panel 122, the sound wave sensor 123 and the power supply module 124. The sound wave sensor 123 can be a piezoelectric microphone, moving-coil microphone or chip microphone. The power supply module 124 can be a rechargeable battery, or a dry battery cell to provide the control module 12 with the necessary working power during an operating mode or stand-by mode, assuring normal and continuous functioning of the sound wave sensor 123. Further, a switch unit 125 is electrically connected to the microprocessor 121. The switch unit 125 can be a push button type, touch control type, piezoelectric type, capacitor type or mechanical type. Further, the switch unit 125 can be mounted on the inside of the housing 11 or in the start-up region 110 of the top cover shell 112, and stopped against or electrically connected to the start-up region 110.

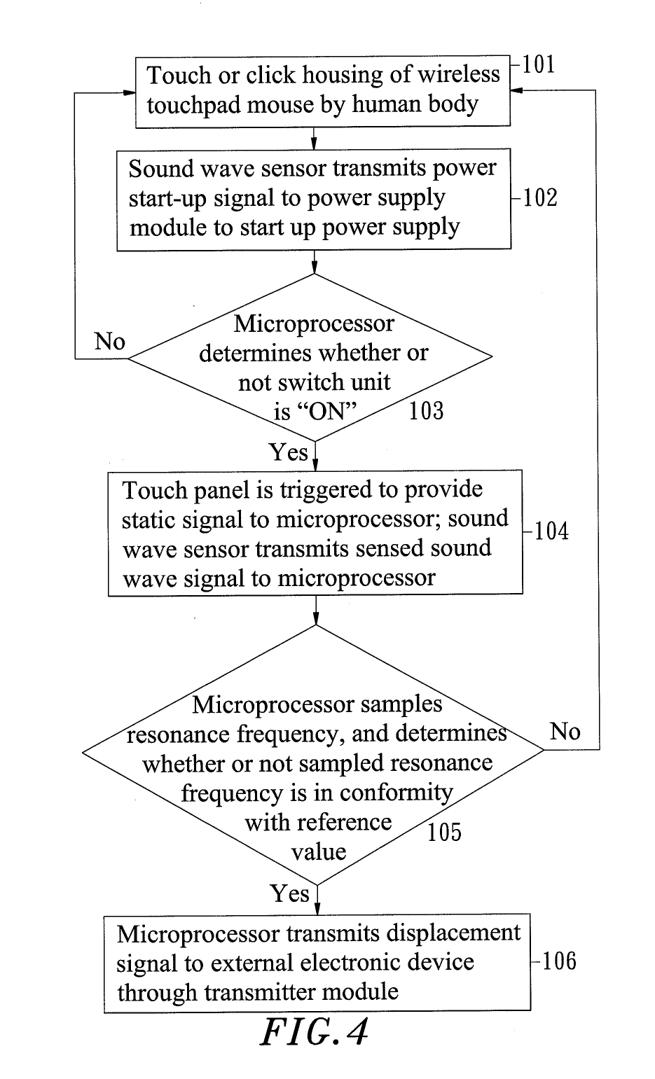

When operating the wireless touchpad mouse 1 to run a touch function, the wireless touchpad mouse 1 is waked up from the stand-by mode subject to the following steps (see FIG. 4):
(101) Touch or click the housing 11 of the wireless touchpad mouse 1 by a part of a human body.
(102) The sound wave sensor 123 transmits a power start-up signal to the power supply module 124 to start up power supply.
(103) The microprocessor 121 determines whether or not the switch unit 125 is in the “ON” position, and then returns to step (101) when negative, or proceeds to step (104) when positive.
(104) The touch panel 122 is triggered to provide a static signal to the microprocessor 121, and at the same time, the sound wave sensor 123 transmits the sensed sound wave signal to the microprocessor 121.
(105) The microprocessor 121 samples the resonance frequency of the sound wave detected by the sound wave sensor 123, and determines whether or not the sampled resonance frequency is in conformity with the reference value built therein, and then returns to step (101) when negative, or proceeds to step (106) when positive.
(106) The microprocessor 121 transmits a displacement signal to an external electronic device 2 through a transmitter module 128.

From the aforesaid steps, it is known that the control module 12 of the wireless touchpad mouse 1 forms an induction loop in the housing 11 so that when the user's finger touches or clicks the housing 1 to produce a resonance of sound waves, the sound wave sensor 123 converts the detected resonance frequency into a voltage signal for causing the power supply module 124 to output power supply subject to the control of the microprocessor 121. Thus, the wireless touchpad mouse 1 is waked up from the stand-by mode. In other words, if the human body does not touch the housing 11 of the wireless touchpad mouse 1, the sound wave sensor 123 does no work, and no any power start-up signal will be outputted. Thereafter, the microprocessor 121 determines whether or not the switch unit 125 is in the “ON” position. If the user touches the start-up region 110 of the top cover shell 112 of the housing 11 with either finger or any part of the hand at this time, the switch unit 125 will be switched on, and this “ON” signal will be received by the microprocessor 121. Therefore, when a human body touches the surface of the wireless touchpad mouse 1, the touch panel 122 is triggered to provide a static signal to the microprocessor 121. This static signal is produced subject to a capacitance charging effect produced at the touch panel 122, i.e., a capacitive coupling is produced between the human body and the touch panel 122. Subject to the volume of the electric current of the static signal, the location of touch is measured, achieving a touch control function. Further, the touch control technology can be the application of surface capacitive touch technology or projected capacitive touch technology. Because the related signal sensing, recognition of multi-touch control (such as scaling, dragging, rotation, etc.) of the touch control technology are of the known art and not within the scope of the claims of the present invention, no further detailed description in this regard is necessary. Further, the aforesaid switching signal and static signal are respectively transmitted to the microprocessor 121. Upon receipt of the switching signal and the static signal, the microprocessor 121 samples the resonance frequency sensed by the sound wave sensor 123, and determines whether or not the sampled resonance frequency is in conformity with the reference value built therein or stored in an external memory (not shown). Preferably, the reference value is within the range of 20 Hz˜20 KHz. However, this range is not a limitation. The range of the reference value may be changed subject to different designs. However, the range of the reference value must exclude the resonance frequency that will be produced when a pet, tabletop office item or any other object touches the wireless touchpad mouse 1 accidentally, avoiding errors.

If the sampled resonance frequency is within the range of the reference value, for example, 20 Hz˜20 KHz, the microprocessor 121 immediately outputs a corresponding triggering signal, i.e., when the microprocessor 121 received the switching signal and the static signal and recognized the sampled resonance frequency to be within the range of the reference value, the touch control system is enabled, and the key value is determined to be effective. Thus, the microprocessor 121 will receive a displacement signal from a displacement sensor module 126. In other words, if the start-up region 110 of the top cover shell 112 of the housing 11 is not touched by a human body, the switch unit 125 is kept in the “OFF” position, and the touch panel 122 gives no signal. Further, if the sampled resonance frequency is out of the range of the reference value, for example, the microprocessor 121 will not receive any signal from the displacement sensor module 126, and the wireless touchpad mouse 1 will be continuously kept in the stand-by mode.

Further, the displacement sensor module 126 that is electrically connected to the wireless touchpad mouse 1 can be an infrared sensor, CMOS (complementary metal-oxide semiconductor) image sensor or CCD (charge coupled device) image sensor. Further, the displacement sensor module 126 works with a LED (light-emitting diode) 127. The LED 127 can be a regular light-emitting diode, infrared light-emitting diode, or a laser LED. The LED 127 emits a light onto a target, and the reflected light from the surface of the target is viewed from an angle by the image sensor of the displacement sensor module 126, and the target's distance is computed from the image pixel data. With respect to how the displacement sensor module 126 generates a projection light, how an image is formed from the reflected light and how the target's distance is computed from the image pixel data, these techniques are of the known art and not within the scope of the claims of the present invention, and therefore no further detailed description in this regard is necessary. Further, when the touch control system is enabled, and the key value is determined to be effective, the microprocessor 121 drives the transmitter module 128 to transmit the displacement signal of the wireless touchpad mouse 1 to a matting receiver module 21 of an external electronic device 2 (such as computer or notebook computer). Further, the transmitter module 128 can be a wireless transmitting interface prepared subject to Bluetooth protocol or radio frequency technology, enabling the wireless touchpad mouse 1 to control the external electronic device 2 in performing cursor operation, program execution, etc.

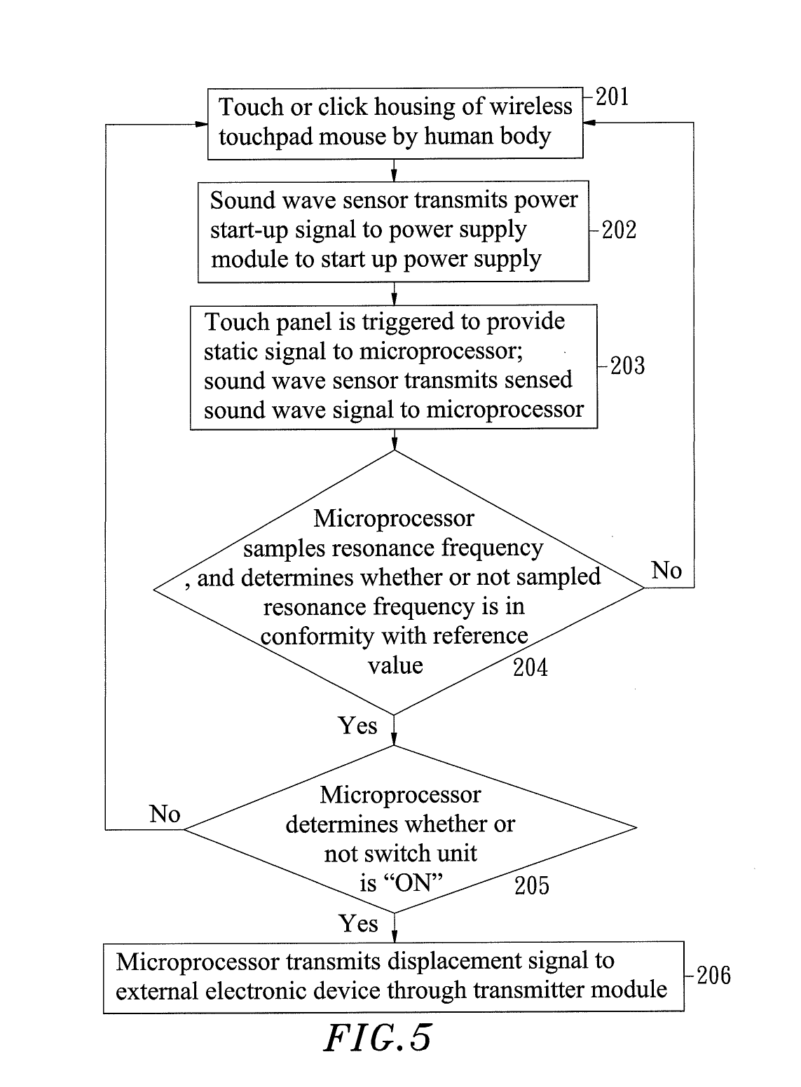

When operating the wireless touchpad mouse 1 to run a touch function, the wireless touchpad mouse 1 can be waked up from the stand-by mode subject to the following steps (see FIG. 5):
(201) Touch or click the housing 11 of the wireless touchpad mouse 1 by a part of a human body.
(202) The sound wave sensor 123 transmits a power start-up signal to the power supply module 124 to start up power supply.
(203) The touch panel 122 is triggered to provide a static signal to the microprocessor 121, and at the same time, the sound wave sensor 123 transmits the sensed sound wave signal to the microprocessor 121.
(204) The microprocessor 121 determines whether or not the switch unit 125 is in the “ON” position, and then returns to step (201) when negative, or proceeds to step (205) when positive.
(205) The microprocessor 121 samples the resonance frequency of the sound wave detected by the sound wave sensor 123, and determines whether or not the sampled resonance frequency is in conformity with the reference value built therein, and then returns to step (201) when negative, or proceeds to step (206) when positive.
(206) The microprocessor 121 transmits a displacement signal to the external electronic device 2 through the transmitter module 128.

As stated above, when the user's finger touches or clicks the housing 1 to produce a resonance of sound waves, the sound wave sensor 123 converts the detected resonance frequency into a voltage signal for causing the power supply module 124 to output power supply subject to the control of the microprocessor 121. Further, when a human body touches the surface of the housing 11 of the wireless touchpad mouse 1 to perform a touch control, the touch panel 122 is triggered to provide a static signal to the microprocessor 121. At the same time, the sound wave sensor 123 provides the sensed sound wave signal to the microprocessor 121. Thereafter, the microprocessor 121 determines whether or not the switch unit 125 is in the “ON” position. If the user touches the start-up region 110 of the top cover shell 112 of the housing 11 with the hand at this time, the switch unit 125 will be switched on, and this “ON” signal will be received by the microprocessor 121. Thereafter, the microprocessor 121 samples the resonance frequency sensed by the sound wave sensor 123, and determines whether or not the sampled resonance frequency is in conformity with the predetermined reference value. If the sampled resonance frequency is within the range of the reference value, the touch control system is enabled, and the key value is determined to be effective. Thus, the microprocessor 121 will receive a displacement signal from the displacement sensor module 126 and drive the transmitter module 128 to transmit the displacement signal to the external electronic device 2, enabling the wireless touchpad mouse 1 to be operated under the operating mode. If the user does not wish to use the wireless touchpad mouse 1, the user can remove the hand from the start-up region 110 to switch off the switch unit 125. Thus, the user can rest the hand on the wireless touchpad mouse 1 without causing movement of the cursor. At this time, the can rest all the fingers or the whole hand on the wireless touchpad mouse 1 without lifting the finger (the forefinger or middle finger for touching the touch panel 122 in controlling the cursor) or leaving the whole hand from the surface of the housing 11. The design of the switch unit 125 provides a multi-touch calibration system, enhancing touch control accuracy and stability and the convenience for use, and avoiding accidental wakeup of the wireless touchpad mouse 1 by errors (for example, touching of the wireless touchpad mouse 1 accidentally by a pet, tabletop office item or any other object) and other improper use (errors instruction, input or program execution actions). Thus, the invention improves the functioning and effect of the product and enhances its market competitiveness.

In conclusion, the invention provides a wireless touchpad mouse 1 having a housing 11 with a start-up region 110 and a control module 12 mounted in the housing 11, wherein the control module 12 comprises a microprocessor 121, a touch panel 122, a sound wave sensor 123, a power supply module 124, a switch unit 125, a displacement sensor module 126 with a LED 127 and a transmitter module 128. When a user touches the surface of the wireless touchpad mouse 1 to start a touch control function, the sound wave sensor 123 converts the resonance of the sensed resonance frequency into a voltage signal for causing the power supply module 124 to output power supply subject to the control of the microprocessor 121. If the user touches the start-up region 110 of the housing 11 at this time, the switch unit 125 will be switched on. When received a switching signal from the switch unit 125 and a static signal from the touch panel 122, the microprocessor 121 samples the resonance frequency sensed by the sound wave sensor 123. If the sampled resonance frequency is within the range of a predetermined reference value, the microprocessor 121 will receive a displacement signal from the displacement sensor module 126 and drives the transmitter module 128 to transmit the displacement signal to a receiver module 21 of an external electronic device 2 wirelessly for cursor control. Thus, the invention assures touch control accuracy and stability, enhances the convenience for use, and avoids errors and improper use of the wireless touchpad mouse 1.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A wireless touchpad mouse, comprising:
a housing defining a start-up region; and
a control module mounted in said housing, said control module comprising a microprocessor, a touch panel electrically connected to said microprocessor and touchable to output a static signal to said microprocessor, a switch unit electrically connected to said microprocessor and adapted for providing a switching signal to said microprocessor when said start-up region is touched by a user, a power supply module electrically connected to said microprocessor, a sound wave sensor electrically connected to said microprocessor and adapted for converting the resonance frequency of sound waves produced upon touch of said housing by a user into a voltage signal for causing said power supply module to output power supply subject to the control of the microprocessor, a displacement sensor module electrically connected to said microprocessor and adapted for providing a displacement signal to said microprocessor when said housing is moved by a user, and a transmitter module electrically connected to said microprocessor and controllable by said microprocessor to transmit said displacement signal to an external electronic device for cursor control.

2. The wireless touchpad mouse as claimed in claim 1, wherein said sound wave sensor is selected from the group of piezoelectric microphone, moving-coil microphone and chip microphone

3. The wireless touchpad mouse as claimed in claim 1, wherein said microprocessor comprises a memory having stored therein a predetermined reference value, said predetermined reference value being within the range of 20 Hz˜20 KHz.

4. The wireless touchpad mouse as claimed in claim 1, wherein said transmitter module is prepared subject to one of the techniques of Bluetooth protocol and radio frequency technology.

5. The wireless touchpad mouse as claimed in claim 1, wherein said displacement sensor module comprises a light-emitting diode adapted for emitting a predetermined light onto a target, and is made in the form of an infrared sensor adapted for picking up the reflected light from the surface of the target and computing the target's distance from the pulse signal of the reflected light.

6. The wireless touchpad mouse as claimed in claim 1, wherein said switch unit is selected from the group of push button type, touch control type, piezoelectric type, capacitor type and mechanical type switches.

7. The wireless touchpad mouse as claimed in claim 1, wherein said power supply module is selected from the group of rechargeable battery and dry battery cell.
